(19) United States
(12) Patent Application Publication
(10) Pub. No.: US 2026/0252526 A1
(43) Pub. Date: Aug. 27, 2026

(54) SYNCHRONIZING DISTRIBUTED DATAFLOW PROGRAMS USING PAIRWISE DATA-DEPENDENCIES

(71) Applicant: SambaNova Systems, Inc., Palo Alto, CA (US)

(72) Inventors: Manish K. SHAH, Austin, TX (US); Kin Hing LEUNG, Cupertino, CA (US); Matthew VILIM, Redwood City, CA (US)

(73) Assignee: SambaNova Systems, Inc., Palo Alto, CA (US)

(21) Appl. No.: 19/247,620

(22) Filed: Jun. 24, 2025

Related U.S. Application Data
(60) Provisional application No. 63/763,829, filed on Feb. 26, 2025.

(51) Int. Cl. G06F 15/78; G06F 9/32

(52) U.S. Cl. CPC G06F 15/7867; G06F 9/321

(57) ABSTRACT

Techniques and systems are disclosed for synchronizing distributed dataflow programs using pairwise data-dependencies in a coarse-grained reconfigurable architecture (CGRA). For example, a system may comprise a producer CGR processor (CGRP) of the plurality of CGRPs configured to load producer configuration data for a producer subgraph of a dataflow program, wherein the producer configuration data configures the producer CGRP to execute the producer subgraph. The producer CGRP may be further configured to execute the producer subgraph to determine, during a program state of the dataflow program, whether a stream ready token (SRT) for the program state was received from a consumer CGRP and, in response to receiving the SRT, send first data for the program state to the consumer CGRP.

### PRIORITY APPLICATION

This application claims the benefit of U.S. Provisional Patent Application No. 63/763,829, filed on Feb. 26, 2025, titled, “Synchronizing distributed dataflow programs using pairwise data dependencies” (Atty. Docket No. SBNV1237USP01). The provisional application is hereby incorporated by reference for all purposes.

### RELATED APPLICATIONS AND REFERENCES

This patent document incorporates the following documents by reference herein for all purposes.

U.S. Provisional Pat. Application, Ser. No. 63/274,304, entitled “Execution State Management,” filed Nov. 1, 2021.

U.S. Pat. Application Publication No. US20230134744A1, entitled “Execution State Management,” published May 4, 2023.

U.S. Pat. No. 10,698,853, entitled “Virtualization of a Reconfigurable Data Processor,” issued Jun. 30, 2020.

U.S. Pat. No. 10,831,507, entitled “Configuration Load of a Reconfigurable Data Processor,” issued Nov. 10, 2020.

Prabhakar et al., “Plasticine: A Reconfigurable Architecture for Parallel Patterns,” ISCA '17, Jun. 24-28, 2017, Toronto, ON, Canada.

SambaNova whitepaper “Accelerated Computing with a Reconfigurable Dataflow Architecture”, available on the sambanova. ai website.

### BACKGROUND

### Technical Field

The technology disclosed relates to synchronization of parallel processing architectures. In particular, it relates to pairwise synchronization of distributed dataflow programs that may be executed across multiple coarse-grained reconfigurable (CGR) processors in a coarse-grained reconfigurable architecture (CGRA).

Reconfigurable processors, which may include coarse-grained reconfigurable (CGR) processors, graphic processing units (GPUs), and field programmable gate arrays (FPGAs), can be configured to implement a variety of functions more efficiently or faster than might be achieved using a general-purpose processor executing a computer program. CGR processors may be developed to include one or more arrays of CGR units (CGR arrays) that can be more complex than those used in typical, more fine-grained FPGAs, and that may enable faster and more efficient execution of various classes of functions. CGR processors have been proposed to provide energy-efficient accelerators for complex dataflow graphs that may be used in, for example, machine learning and artificial intelligence workloads.

A dataflow program may be a graph of virtual compute and memory units, which can be mapped onto a fabric of physical units of a CGR processor, also known as a reconfigurable dataflow unit (RDU). If a program exceeds the capacity of a single CGR processor, the program may be partitioned across multiple CGR processors, and inter-processor streams between producer and consumer on different CGR processors may extend the fabric. Synchronization between CGR processors may be required when an inter-processor stream dependency exists.

### SUMMARY

The disclosed technology may provide a method and system for synchronizing distributed dataflow programs using pairwise data-dependencies in a coarse-grained reconfigurable architecture (CGRA). Any CGR processor in the system may have a data-dependence on a subset of other CGR processors, and a producer CGR processor in a program state may send data to a consumer CGR processor that may be in the same program state. Synchronization can occur between producer/consumer pairs that may share an inter-processor stream, using stream ready tokens (SRTs) that can be managed by a persistent token bank (PTB). Intra-processor streams may execute while the producer CGR processor awaits the SRT to reduce synchronization latency, and the system can maintain a program skew of one program state between CGR processors sharing inter-processor streams.

### BRIEF DESCRIPTION OF THE DRAWINGS

FIG. 1 illustrates an example system including a host, a data bus, a token bus, and two or more coarse-grained reconfigurable (CGR) processors.

FIG. 2 illustrates an example system including a host, a data bus, and a CGR processor that includes multiple CGR arrays.

FIG. 3 illustrates an implementation of a token interface for communication between a system-level token bus and a processor-level token bus.

FIG. 4 illustrates details of an example CGRA that includes a top-level network, a token bus, and two CGR arrays.

FIG. 5 illustrates an example CGR array, including an array of CGR units in an array-level network (ALN).

FIG. 6 illustrates an implementation of a system with a logical CGR array spanning multiple CGR processors.

FIG. 7 illustrates pairwise inter-processor synchronization between a producer CGR processor and a consumer CGR processor.

FIG. 8 illustrates an example system with multiple CGR processors and disjoint subgraphs with data dependencies.

FIG. 9 illustrates intra-processor synchronization within a single CGR processor using SRT tokens.

FIG. 10 illustrates the structure of the persistent token bank (PTB) for managing stream ready tokens (SRTs).

FIG. 11 illustrates the control handshake between a producer CGR processor and a consumer CGR processor for pairwise synchronization.

FIG. 12A illustrates synchronization latency for a pairwise synchronization case where the producer leads the consumer.

FIG. 12B illustrates synchronization latency for a pairwise synchronization case where the consumer leads the producer.

FIG. 13 is a flowchart illustrating a process for synchronizing distributed dataflow programs using pairwise data-dependencies in a coarse-grained reconfigurable architecture (CGRA).

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope of the claims. Instead, they merely represent examples of different implementations of the disclosed technology.

### DETAILED DESCRIPTION

Reconfigurable processors, which may include coarse-grained reconfigurable (CGR) processors, graphic processing units (GPUs), and field programmable gate arrays (FPGAs), can be configured to implement a variety of functions more efficiently or faster than might be achieved using a general-purpose processor executing a computer program. CGR processors may be developed to include one or more arrays of CGR units (CGR arrays) that can be more complex than those used in typical, more fine-grained FPGAs, and that may enable faster and more efficient execution of various classes of functions. CGR processors may provide energy-efficient accelerators for complex dataflow graphs that can be used in, for example, machine learning and artificial intelligence workloads. See, Prabhakar, et al., “Plasticine: A Reconfigurable Architecture for Parallel Patterns,” ISCA '17, Jun. 24-28, 2017, Toronto, ON, Canada.

Configuration of CGR processors may involve compilation of a high-level program that can comprise one or more dataflow graphs into configuration data for the CGR units in the CGR arrays, and distribution of the configuration data to the CGR processor. To start a process that may be implemented using a dataflow graph, the configuration data can be loaded for that process. To change a process implementing a dataflow graph, the configuration data may be replaced.

A CGR array can provide parallel processing of multiple interdependent but asynchronous meta-pipelines that may be included in a dataflow graph. The CGR array may comprise an array-level network (ALN) of CGR units. Different CGR arrays can communicate with each other via a top-level network (TLN). The CGR units may include compute units and memory units. In some implementations, a single CGR array can concurrently run multiple dataflow graphs. In other implementations, a single dataflow graph may utilize multiple CGR arrays, or even multiple CGR processors.

A CGR processor, and each CGR array the CGR processor may incorporate, can enter an execution state to run the dataflow graph that may be loaded on the CGR processor. In a system with multiple CGR processors, each processor may reach the execution state at a different time, since a program load operation can complete in any order among the processors. When running a program that may use multiple CGR processors, each processor can synchronize with its peer processors that may have direct data dependencies before initiating peer-to-peer (P2P) communication over inter-processor streams. Synchronization can occur between producer/consumer pairs using stream ready tokens (SRTs) that may be managed by a persistent token bank (PTB), and intra-processor streams may execute concurrently to reduce synchronization latency.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, and C” or the phrase “at least one of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The following terms or acronyms used herein are defined at least in part as follows:
AGCU—address generator (AG) and coalescing unit (CU).
AI—artificial intelligence.
ALN—array-level network.
CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units.
Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU.
CGR processor—a unit in a CGRA that includes one or more CGR arrays and a token interface with a PTB, capable of executing a sub-program of a distributed dataflow program and synchronizing with other CGR processors using SRTs. A CGR processor may also be referred to as a reconfigurable dataflow unit (RDU).
CU—coalescing unit.
Dataflow Graph—a computation graph that includes one or more loops that may be nested, and wherein nodes can send messages to nodes in earlier layers to control the dataflow between the layers.
FIFO—First-in, first-out memory. A serial memory that may store data of variable length, and in which data may be stored until the data has been read and is overwritten. Often, a FIFO has separate write and read ports and separate write and read strobe inputs. Data is read in the order in which the data was written.
FCMU—fused compute and memory unit—a circuit that includes both a memory unit and a compute unit.
GPU—graphic processing unit
Graph—a collection of nodes connected by edges. Nodes may represent various kinds of items or operations, dependent on the type of graph. Edges may represent relationships, directions, dependencies, etc.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on a CGR array.
A logical CGR processor—a CGR processor that is physically feasible although the logical CGR processor may be too large for a monolithic implementation, but that may not have been assigned to one or more physical CGR processors.
ML—machine learning.
PCU—pattern compute unit—a compute unit that can be configured to repetitively perform a sequence of operations.
PMU—pattern memory unit—a memory unit that can locally store data according to a programmed pattern.
PTB—Persistent Token Bank—a hardware structure in each CGR processor that stores stream ready tokens (SRTs), comprising up/down counters organized into odd and even banks to manage tokens across program states.
RDU—econfigurable dataflow unit—an alternate term for a CGR processor, a unit in a CGRA that includes one or more CGR arrays and a token interface with a PTB, capable of executing a sub-program of a distributed dataflow program and synchronizing with other units using SRTs.
SRT—Stream Ready Token—a token used for pairwise synchronization, including a stream identifier and a program identifier bit indicating an odd or even program state.
Step—a method may include multiple steps. Some implementations execute the steps in the order described herein, and other implementations may execute the steps in a different order. Further implementations may execute additional steps.
TLN—top-level network.
WD—write data.
Inter-processor stream—A stream whose consumer is on another CGR processor. A producer CGR processor in program N can start the stream when the consumer CGR processor is also in program N.
Intra-processor stream—A stream whose consumer is on the same CGR processor. These streams are triggered by the local intra-processor barrier token.

### Implementations

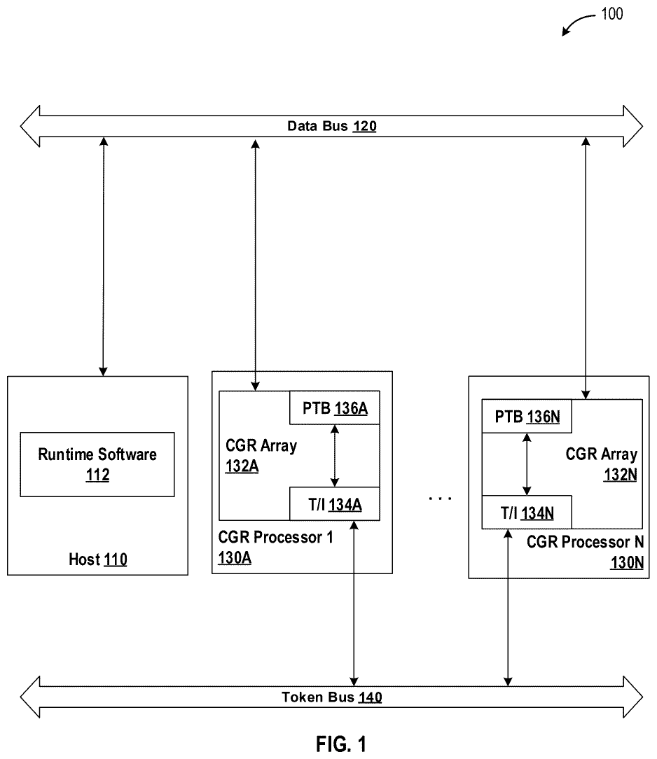

FIG. 1 illustrates an example system 100 that can include a host 110, a data bus 120, a token bus 140, and two or more coarse-grained reconfigurable (CGR) processors 130A-N. Host 110 and each CGR processor 130A-N may be coupled with data bus 120.

Each CGR processor 130A-N may include a CGR array 132A-N with a token interface (T/I) 134A-N that can communicate with the token bus 140. The CGR array 132A-N may communicate with data bus 120, which can be part of the TLN. The TLN may include an input/output (I/O) interface that can link information flow internal to CGR processor 130A-N to the external data bus 120. However, while illustrated as a single bus, the data bus 120 between the host 110 and each CGR processor 130A-N may be any configuration including that illustrated or configurations such as one in which the Top-Level Network (TLN) bridges to PCIe, memory, and D2D buses on the CGR processors or other such variations.

The separation of the token bus 140 and data bus 120 (and similar separations in subsequent FIGS.) may be logical or physical. For example, some implementations may combine the token bus 140 and data bus 120, but, for example, may give token messages a different address than other messages not associated with tokens. In other implementations, the token bus 140 and data bus 120 may be physically separate, as drawn. Data bus 120 may be, or may include, any non-standard or standard data bus, such as PCIe.

Host 110 may execute various processes using runtime software 112, for example, compilation (which can occur prior to configuration of the CGR processors 130A-N); loading, updating, and unloading configuration data; and runtime processes. Once execution of a high-level program starts, CGR processors 130A-N may communicate via the token bus 140 using stream ready tokens (SRTs) to coordinate execution of dataflow graphs across processors with direct data dependencies.

Each CGR processor 130A-N may include a persistent token bank (PTB) 136A-N that can store SRTs, which may enable pairwise synchronization between producer and consumer processors.

A dataflow graph, for the purposes of this description, may include the configuration file that can be compiled to execute a mission function procedure or set of procedures using the CGR processor(s) 130A-N, such as inferencing or learning in an artificial intelligence or machine learning system. A logical CGR array may comprise a set of resources that can be configured to support execution of an application graph in a CGR array 132A-N, or multiple synchronized CGR arrays, in a manner that may appear to the dataflow graph as if the resources were located in a single physical CGR array.

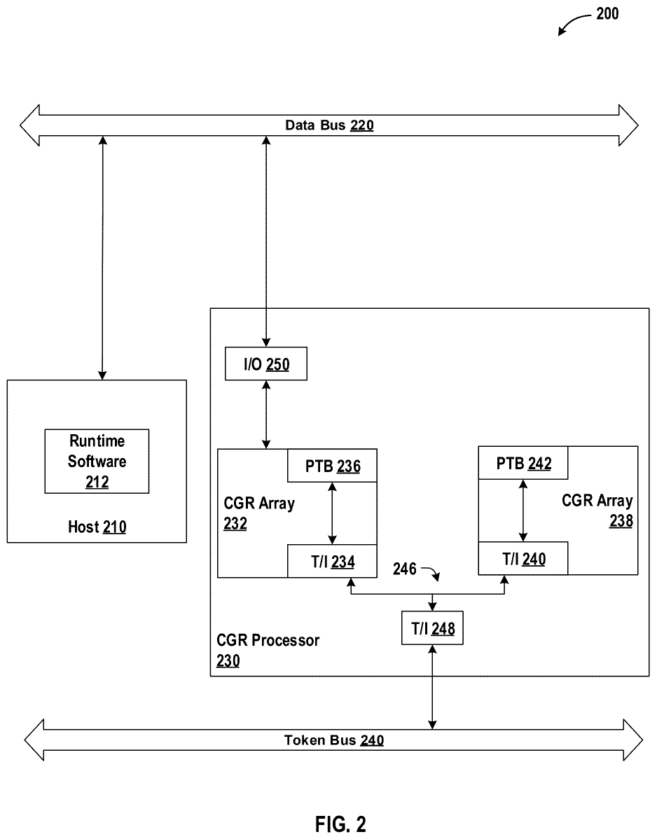

A CGR processor 130A-N may be implemented on a single CGRA integrated circuit (IC) die or on a multichip module (MCM). An IC may be packaged in a single chip module or a multichip module. In some implementations, a CGR processor 130A-N may include one or more CGR arrays 132A-N, each of which can be equipped with a token interface 134A-N and a PTB 136A-N. FIG. 2 illustrates an example system 200 that can include a host 210 with runtime software 212, a data bus 220, and a CGR processor 230 that may include multiple CGR arrays 232, 238. Host 210 and CGR processor 230 may be coupled with data bus 220.

Each CGR array 232, 238 may be coupled with a TLN, which can include internal data channels, an I/O interface 250, and data bus 220. Each CGR array 232, 238 may include a token interface (T/I) 234, 240 with a PTB 236, 242 that can interface with processor-level token interface 248 via a processor-level token bus 246.

Token interface 248 may be coupled with a system-level token bus 240. System-level token bus 240 may be physically separate from data bus 220, or the system-level token bus may be integrated with data bus 220.

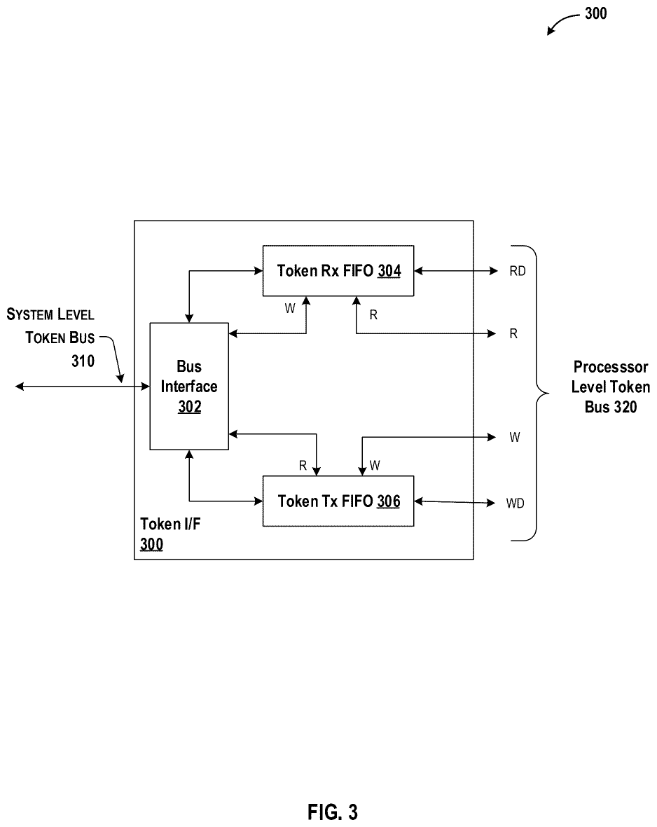

FIG. 3 illustrates an implementation of a token interface 300 that can be used for communication between a system-level token bus 310 and a processor-level token bus 320, or between a processor-level token bus and an array-level token bus.

Token interface 300 may comprise a bus interface 302, a token receive FIFO 304, and a token transmit FIFO 306. Bus interface 302 may control writing into token receive FIFO 304 and reading from token transmit FIFO 306, whereas processor-level token bus 320 (or the array-level token bus) may control reading from token receive FIFO 304 and writing into token transmit FIFO 306.

Bus interface 302 may comprise, for example, a PCIe PHY and controller. Token receive FIFO 304 may have a data input that can be coupled with a token output of bus interface 302 and a write clock input W that may be coupled to a token write clock output of bus interface 302. Token receive FIFO 304 may further have a data output coupled with a read data (RD) input of processor-level token bus 320 for transmitting tokens to components within the CGR processor, such as a persistent token bank (PTB), and a read clock input R that can be coupled to a read clock output R of processor-level token bus 320.

Token transmit FIFO 306 may have a data input that can be coupled with a write data (WD) output of processor-level token bus 320, a write clock input W that may be coupled with a write clock output W of processor-level token bus 320, a data output that can be coupled with a token input of bus interface 302, and a read clock input R that may be coupled with a token read clock output of bus interface 302.

Token interface 300 may be configured to be available and operating from a time when CGR arrays may not be available and operating yet, until after the CGR arrays may have operated (e.g., executed a program) and may have become idle. Thus, token interface 300 may receive tokens, such as stream ready tokens (SRTs), while the CGR array may be unavailable, and can forward them to the PTB within the CGR processor for processing.

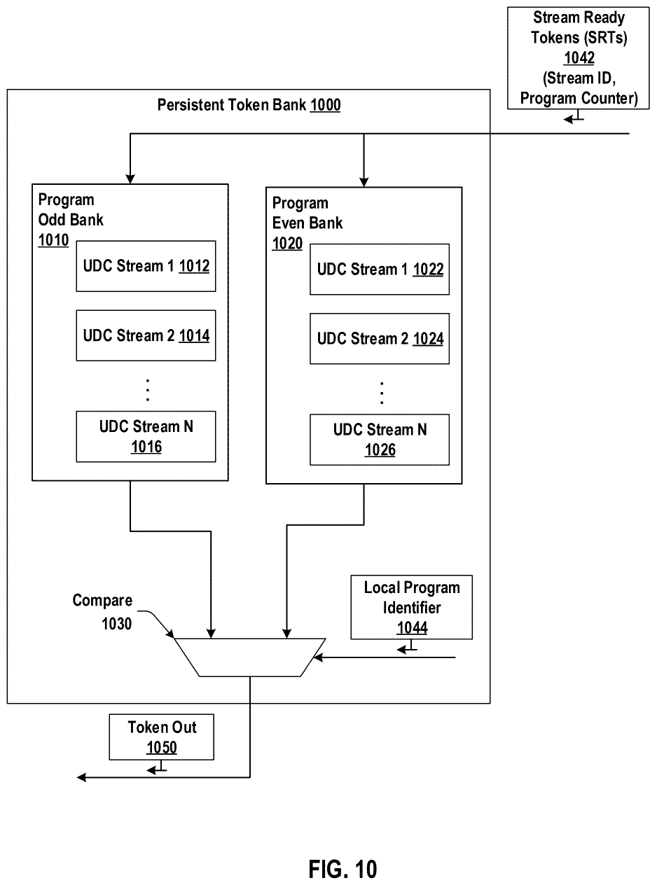

To transmit a token, the CGR processor may write the token into token transmit FIFO 306, and bus interface 302 may collect the token from token transmit FIFO 306 as soon as the token may be available to transmit. CGR processor may receive SRTs from the token receive FIFO 304 and store them into odd and even counter banks of the PTB based on the program counter bit in each SRT, as described further in FIG. 10.

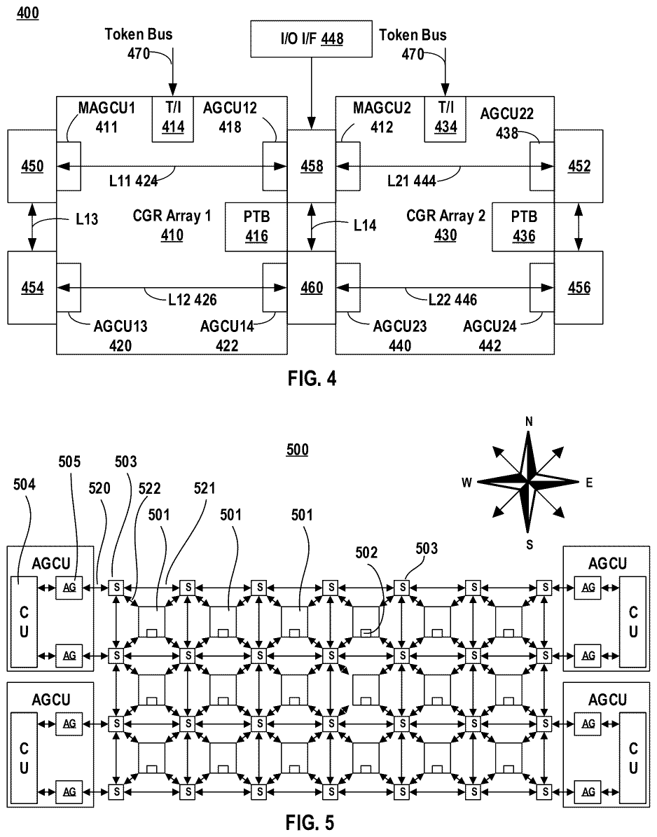

FIG. 4 illustrates details of an example CGRA that can include a top-level network, a token bus 470, and two CGR arrays 410, 430. Other implementations may include fewer or more CGR arrays. A CGR array may comprise an array of CGR units that can be interconnected via an ALN. The architecture may include a TLN that can couple the CGR arrays to external I/O interface 448 (or any number of interfaces). Other implementations may use different bus architectures. CGR units may be networking nodes on the ALN.

In this example architecture, each CGR array 410, 430 may have four address generator and coalescing units (AGCUs). CGR array 410 may include a master AGCU (MAGCU1) 411, along with AGCUs 418, 420, 422, while CGR array 430 may include a master AGCU (MAGCU2) 412, along with AGCUs 438, 440, 442. The MAGCU1 411 may include a configuration load/unload controller for CGR array 410, and the MAGCU2 412 may include a configuration load/unload controller for CGR array 430. The configuration load/unload controller can manage loading and unloading of configuration data for the respective CGR array. In some implementations, a configuration load/unload controller can be configured to manage loading and unloading for more than one CGR array, or the loading and unloading of configuration data for the respective CGR array can be implemented by logic distributed among multiple AGCUs. The AGCUs may be networking nodes on the TLN and can also be networking nodes on their respective ALNs. An AGCU may include circuits for routing data among networking nodes on the TLN and on their respective ALNs.

Networking nodes on the TLN in this example may include one or more external I/O interfaces, which can include external I/O interface 448. The interfaces to external devices may include circuits for routing data among networking nodes on the TLN and external devices, such as high-capacity memory, host processors, other CGR processors, GPUs, FPGA devices, and so on, that may be coupled with the interfaces.

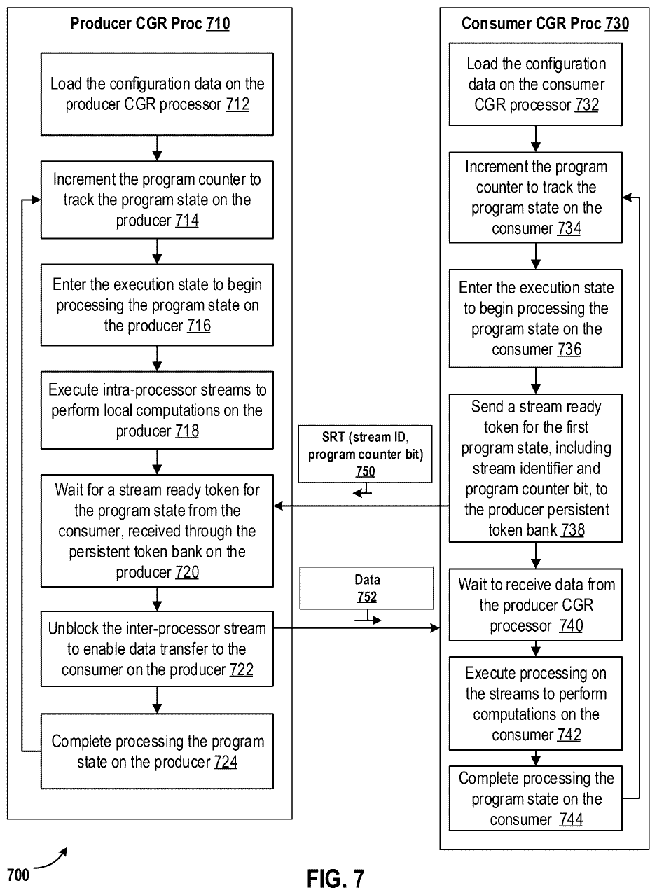

Each CGR array 410, 430 may include a token interface (T/I) 414, 434 with a PTB 416, 436 that can manage SRTs for pairwise synchronization between producer and consumer CGR processors. PTB 416, 436 may store SRTs in counter banks based on the program counter bit. The array may then be able to cause the PTB to release SRTs from locations matching the program state mod 2 of the CGR processor, allowing examination of the stream identifier to identify the requesting consumer and unblock inter-processor streams, as further described with reference to FIG. 7.

TLN may include top-level switches 458, 460, 454, 452, 450, 456 that can be coupled with each other as well as with other nodes on the TLN, which may include the AGCUs, and external I/O interface 448. The TLN may include links (e.g., L11 424, L12 426, L13 454, L14 452, L21 444, L22 446) that can connect the top-level switches. The links can include one or more buses and supporting control lines, such as a chunk-wide vector bus. The links can support data transfer protocols, such as an Advanced eXtensible Interface (AXI)-compatible protocol, to facilitate coordinated transfer of data. Data may travel in packets between the top-level switches on the links, and from the switches to the CGR units and vice versa. The top-level switches 458, 460, 454, 452, 450, 456 can be coupled with the AGCUs. The top-level switch 458 can be coupled with the MAGCU1 411. The top-level switch 460 can be coupled with the AGCU 418. The top-level switch 454 can be coupled with the AGCU 420. The top-level switch 452 can be coupled with the AGCU 422. The top-level switch 460 can be coupled with the MAGCU2 412. The top-level switch 450 can be coupled with the AGCU 438. The top-level switch 456 can be coupled with the AGCU 440. The top-level switch 452 can be coupled with the AGCU 442.

It should be noted that, while specific examples and details of particular examples of the interconnect and buses such as the TLN, the data buses, token buses and so on are shown herein, implementations are not limited to these specifics and details. For example, the TLN, data buses and/or token buses may or may not couple the host to the CGR processors or the CGR processors to other CGR processors directly, with other or additional buses, components or configurations being contemplated.

FIG. 5 illustrates an example CGR array 500, which can include an array of CGR units 501 in an ALN. CGR array 500 may include several types of CGR unit 501, such as FCMUs, PMUs, PCUs, memory units, and/or compute units. Functions of the CGR units 501 are further described in Prabhakar et al., “Plasticine: A Reconfigurable Architecture for Parallel Patterns,” ISCA 2017, Jun. 24-28, 2017, Toronto, ON, Canada. Each of the CGR units 501 may include a configuration store 502 that can comprise a set of registers or flip-flops that may store configuration data representing the setup and/or the sequence to run a program. The configuration data can include a number of nested loops, limits of each loop iterator, instructions to be executed for each stage, a source of operands, and network parameters for input and output interfaces. In some implementations, communication channels in the ALN can be configured as end-to-end connections. The switch units 503 can comprise CGR units in these implementations. In other implementations, the switch units 503 can route data via available links based on address information in packet headers. Communication channels can be established as needed in such cases.

In some implementations, each CGR unit 501 may comprise an FCMU. In other implementations, the array may comprise both PMUs and PCUs, or memory units and compute units, which can be arranged in a checkerboard pattern. The ALN may include switch units 503 (S), and AGCUs (each of which may include two address generators (AG) 505 and a shared coalescing unit (CU) 504). Switch units 503 may be connected among themselves via interconnects 521 and to a CGR unit 501 with interconnects 522. Switch units 503 may be coupled with an AG 505 via interconnects 520.

A configuration file may include configuration data that can represent an initial configuration, or starting state, of each of the CGR units 501 that may execute a high-level program with user algorithms and functions. Program load may be the process of setting up the configuration stores in the CGR array 500 based on the configuration data to allow the CGR units 501 to execute the high-level program.

The ALN may include one or more kinds of physical data buses, for example a chunk-level vector bus (e.g., 512 bits of data), a word-level scalar bus (e.g., 32 bits of data), and a control bus. The data buses can differ in granularity of data being transferred. The vector bus can carry a chunk that can include 16 channels of 32-bit data or 32 channels of 16-bit data as a payload. The scalar bus can have a 32-bit payload that can carry scalar operands or control information. The control bus can carry control handshakes, such as tokens and other signals. The vector bus and the scalar bus can be packet-switched. The vector bus and the scalar bus can include headers that can indicate a destination of each packet and sequence numbers that can be used to reassemble a file when the packets are received out of order. Each packet header can include a destination identifier that can identify geographical coordinates of a destination switch unit, such as a row and a column in the CGR array 500, and an interface identifier that can identify an interface on the destination switch unit used to reach a destination CGR unit 501. A control bus may comprise a configurable interconnect that can carry multiple control bits on signal routes that may be designated by configuration bits in the CGR array configuration file.

A CGR unit 501 may comprise four ports to interface with the switch units 503. Each port can be configured for receiving and transmitting data. Each switch unit 503 may comprise eight interfaces. A north interface, a south interface, an east interface, and a west interface of the switch unit 503 can be used for links between the switch units 503 using the interconnects 521. A northeast interface, a southeast interface, a northwest interface, and a southwest interface of the switch unit 503 can be used to couple with an FCMU, a PCU, or a PMU instance of the CGR units 501 using the interconnects 522. Each interface of the switch unit 503 can include a vector interface, a scalar interface, and a control interface to communicate with a vector network, a scalar network, and a control network, respectively. Two switch units 503 in each quadrant of the CGR array 500 can comprise links to an AGCU using the interconnects 520. The shared coalescing unit (CU) 504 of the AGCU can arbitrate between the address generators (AG) 505 and can process memory requests.

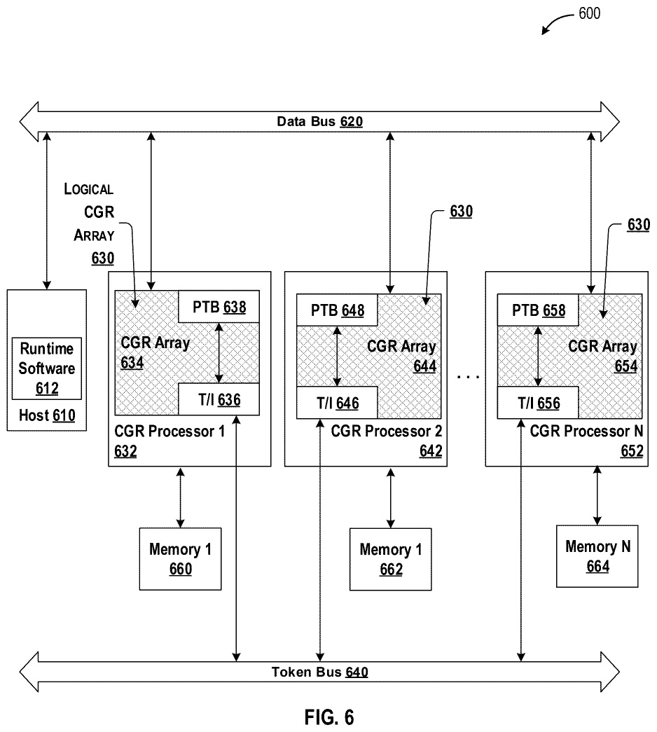

FIG. 6 illustrates an implementation of a system 600 with a logical CGR array 630 that can span multiple CGR processor devices 632, 642, 652. System 600 may include host 610 with runtime software 612 which can be coupled with CGR processor 632, CGR processor 642, and CGR processor 652 via one or more buses (e.g., a data bus 220, a token bus 240, etc.).

Each CGR processor 632, 642, 652 may be coupled with a memory, for example, logical CGR array 630 may be coupled with memory 660, CGR processor 642 may be coupled with memory 662, and CGR processor 652 may be coupled with memory 664, wherein the host 610 can communicate with the memory 660, 662, 664 via a TLN in the CGR processor 632, 642, 652, respectively. System 600 may include any number of CGR processors and memories. The CGR processors 632, 642, 652 may each be implemented on a single IC, and can include one or more CGR arrays, such as the CGR array 500 described with reference to FIG. 5. Each CGR processor 632, 642, 652 may be associated and coupled with a token interface (T/I) 636, 646, 656 that can include a PTB 638, 648, 658.

A logical CGR array 630, as opposed to a physical CGR array, may be configured to act as a single machine for execution of a single program (or dataflow graph). Logical CGR array 630 may span multiple physical CGR arrays 634, 644, 654, for instance in the example shown, the CGR arrays in CGR processor 632, CGR processor 642, and CGR processor 652. In the image, the logical CGR array 630 may be indicated by cross-hatching within the CGR arrays 634, 644, 654.

At the time of partitioning, a runtime daemon may add program synchronization code to an application graph running in each physical CGR array to support a pairwise synchronization protocol between CGR processors sharing inter-processor streams (e.g., sharing pairwise data dependencies). A portion of the application graph assigned to a first physical CGR array can be executed on a second physical CGR array to support overflow partitioning for resource utilization optimization.

System 600 may include a plurality of CGR processors 632, 642, 652 that can be coupled with a plurality of memory units 660, 662, 664 via one or more buses that can include a data bus 620 and a token bus, wherein the token bus can be implemented as a system-level token bus 240, as shown in FIG. 2.

FIG. 7 illustrates a flowchart of one example of a computer-implemented synchronization method 700 that can occur between producer CGR processor 710 and consumer CGR processor 730 in a coarse-grained reconfigurable architecture (CGRA). Method 700 may contribute to efficient execution of distributed dataflow programs. Method 700 may coordinate producer CGR processor 710 and consumer CGR processor 730 using stream ready tokens (SRTs) and a persistent token bank (PTB).

At block 712, producer CGR processor 710 may load configuration data on producer CGR processor 710 for a producer subgraph of a distributed dataflow program. In some examples, producer CGR processor 710 may initialize a program counter to a pre-execution value (e.g., a value of 0, in an example where the first valid program state during execution is 1).

At block 714, producer CGR processor 710 may increment the program counter for the program state on producer CGR processor 710.

At block 716, producer CGR processor 710 may enter the execution state to begin processing the program state on producer CGR processor 710. Producer CGR processor 710 may generate a program start token to initiate the synchronization process, barring intra-processor streams to prevent premature execution.

At block 718, producer CGR processor 710 may execute intra-processor streams to perform local computations (e.g. intra-processor processing) on producer CGR processor 710. Producer CGR processor 710 may unblock local streams as part of beginning the execution of intra-processor streams, which may reduce synchronization latency by allowing local execution while awaiting stream ready tokens (SRTs) for the program state.

At block 720, producer CGR processor 710 may wait for an SRT for the program state from consumer CGR processor 730, received through the persistent token bank (PTB) on producer CGR processor 710 via a token interface, such as the token interface 300 described with reference to FIG. 3. More particularly, as SRTs 750 are received from the consumer CGR processor 730, the SRT may be stored in matching PTB locations (e.g., based on the program counter bit). Depending on the example, the matching PTB location may also be determined based on the stream identifier of the SRT. Producer CGR processor 710 may cause PTB to release any SRTs from the location or locations matching the program counter mod 2 of producer CGR processor 710 (e.g., odd or even storage locations). Release of SRTs may occur upon entering the execution state, concurrent with block 718, if the producer CGR processor 710 has already received the SRT for the program state from the consumer CGR processor 730. In some examples, producer CGR processor 710 may examine the stream identifier in the SRT to identify consumer CGR processor 730 requesting the data stream. Upon receiving the SRT, producer CGR processor 710 may proceed to block 722.

At block 722, producer CGR processor 710 may unblock the inter-processor stream to enable data transfer to consumer CGR processor 730 when the program state mod 2 and the matching SRT are received, triggering or allowing communication of the data 752 from producer CGR processor 710 to consumer CGR processor 730.

At block 724, producer CGR processor 710 may complete processing for the program state on producer CGR processor 710. Producer CGR processor 710 may wait for the inter-processor stream to complete data transfer to consumer CGR processor 730, ensuring all data has been successfully sent prior to incrementing the program counter for the next state at block 714. Producer CGR processor 710 may barrier intra-processor store streams to local memory to mark the end of the current program execution phase. Producer CGR processor 710 may then finalize the program state and prepare for transitioning to the next program state, ensuring readiness for subsequent operations with consumer CGR processor 730 in the next program state cycle. In some implementations, producer CGR processor 710 may increment the program counter to the next state (e.g., return to block 714) while transferring the data, such as when a buffer or memory area ensures that the current program state data being transferred will not be overwritten by the next state's processing. In such an example, the block on inter-stream transfers for program state N+1 until an SRT for program state N+1 may ensure the data is sent (e.g., because consumer CGR processor 730 will not generate an SRT for program state N+1 until after receiving data for program state N).

Turning to the consumer CGR processor 730, at block 732, consumer CGR processor 730 may load configuration data on consumer CGR processor 730 for a consumer subgraph of the distributed dataflow program. In some examples, consumer CGR processor 730 may initialize a program counter to a pre-execution value.

At block 734, consumer CGR processor 730 may increment the program counter for the program state on consumer CGR processor 730.

At block 736, consumer CGR processor 730 may enter the execution state to begin processing the program state on consumer CGR processor 730.

At block 738, consumer CGR processor 730 may send an SRT for the program state to PTB on producer CGR processor 710. Consumer CGR processor 730 may generate a program identifier bit based on the program counter by performing a mod 2 operation, indicating an odd or even program state. The SRT may include a stream identifier and the program identifier bit, signaling readiness to receive data from producer CGR processor 710.

At block 740, consumer CGR processor 730 may wait to receive data 752 from producer CGR processor 710 after the inter-processor stream is unblocked on producer CGR processor 710.

At block 742, consumer CGR processor 730 may execute processing on the streams to perform local computations. In some examples, after processing the data 752, consumer CGR processor 730 may send a credit return token to producer CGR processor 710 to manage software flow control, ensuring proper data transfer pacing between producer CGR processor 710 and consumer CGR processor 730.

At block 744, consumer CGR processor 730 may complete processing for the program state on consumer CGR processor 730. In some examples, consumer CGR processor 730 may wait for data processing to complete on the streams, ensuring all received data has been handled. In some implementations, consumer CGR processor 730 may prioritize processing of critical data segments to optimize performance. Upon completion of processing for the program state, consumer CGR processor 730 may leave the execution state, marking the end of the current program execution phase, and finalize the program state to prepare for transitioning to the next program state, ensuring readiness for subsequent operations with producer CGR processor 710 in the next program state cycle (e.g., after returning to block 734).

While shown and discussed with regard to a single consumer CGR processor 730, in some examples, producer CGR processor 710 may have multiple consumer CGR processors for the subgraph. In such cases, producer CGR processor 710 may wait for all SRTs to be received before continuing to block 722, or producer CGR processor 710 may perform block 722 with respect to each consumer CGR processor an SRT is received for, and await the receipt of all SRTs before completing block 724.

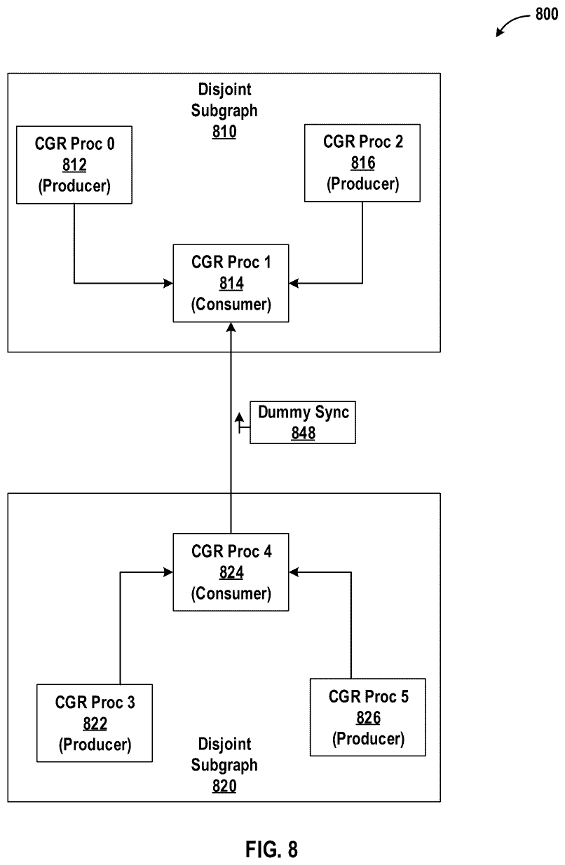

FIG. 8 illustrates an example system 800 that can include multiple CGR processors 812, 814, 816, 822, 824, and 826 and disjoint subgraphs 810, 820 with data dependencies. The dataflow program may be partitioned into the disjoint subgraphs 810, 820 based on data dependencies identified within the computation graph. Such partitioning may allow each subgraph to execute independently on a subset of the CGR processors with minimal inter-subgraph communication. In subgraph 810, CGR processor 0 812 and CGR processor 2 816 may produce data for CGR processor 1 814, while in subgraph 820, CGR processor 3 822 and CGR processor 5 826 may produce data for CGR processor 4 824. A dummy sync 848 may be used between subgraphs 810 and 820 to ensure loose synchronization when there is no strict data dependency between the subgraphs. For example, a dummy sync may be inserted during partitioning when the partitioning process determines that the subgraphs, while not directly data dependent, may operate better with a loose synchronization.

A dummy sync 848 may be an SRT (e.g., a dummy synchronization token) that can be inserted during partitioning and can be released by one subgraph 810 to another subgraph 820 when two disjoint subgraphs of CGR processors may not share a true data dependency. The dummy sync 848 can ensure that the subgraphs 810, 820 remain loosely synchronized within the broader program synchronization protocol by allowing one subgraph to wait for the other to reach a corresponding program state before proceeding, using the pairwise synchronization mechanism described with reference to FIG. 7, but may be different from direct data exchange, thereby maintaining overall system coherence without using direct data exchange. In such a case, the CGR processor acting as a producer CGR processor for the dummy sync SRT may be configured to hold at a program state (e.g., program state N) until the dummy sync SRT is received, after which it may proceed as if the inter-processor stream is completed.

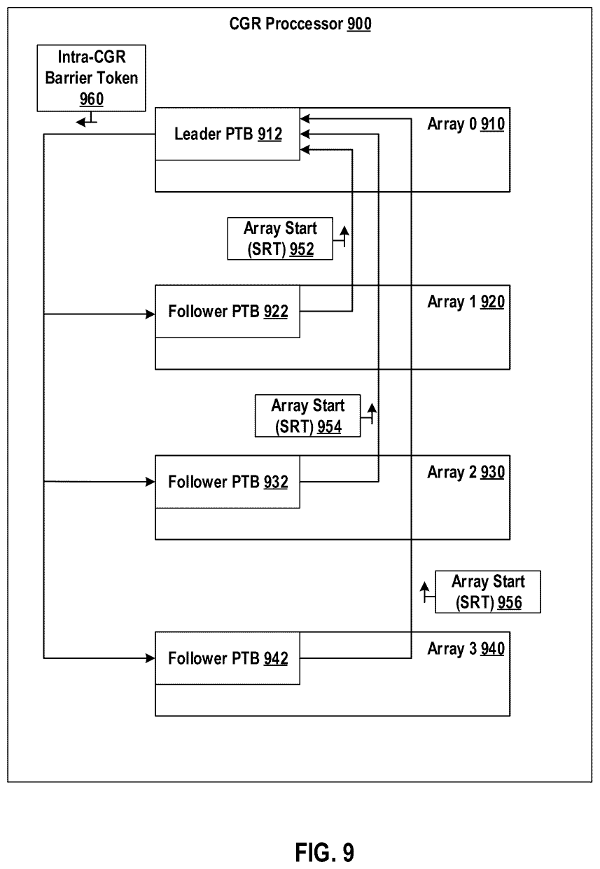

FIG. 9 illustrates intra-processor synchronization that can occur within a single CGR processor 900. Stream ready tokens (SRTs) may be used to synchronize arrays 910, 920, 930, 940 within a CGR processor 900. Each CGR processor 900 may contain multiple, independent arrays, each of which can have its own program state machine.

Intra-processor communication between arrays 910, 920, 930, and 940 may be safe when all arrays may have finished program load and may have entered the same program state. The arrays may include a leader array 910 and follower arrays 920, 930, and 940. In some implementations, the designation of the leader array can be dynamically assigned based on runtime conditions, such as workload distribution or array availability, or the designation of the leader array can be statically determined by the compiler during program partitioning. The leader array 910 may include a leader persistent token bank (PTB) 912, and each follower array 920, 930, and 940 may include its own follower PTB 922, 932, and 942, respectively. To synchronize arrays, each follower array local program start of a program state may be sent as a local SRT to the leader PTB 912, which may be facilitated via a token interface (T/I) associated with the leader PTB 912. In the figure, these SRTs may be represented as Array Start (SRT) 952 from follower PTB 922 of array 920, Array Start (SRT) 954 from follower PTB 932 of array 930, and Array Start (SRT) 956 from follower PTB 942 of array 940, each directed to the leader PTB 912.

When the leader array 910 may begin the program state, these SRTs may be released from the leader PTB 912 and can be routed to a barrier semaphore. When the semaphore may reach its threshold, an intra-processor barrier token 960 may be broadcast to all follower PTBs 922, 932, and 942 to unblock intra-processor streams in the follower arrays 920, 930, and 940. In some implementations, the barrier semaphore threshold can be configured to block broadcasting of the intra-processor barrier token 960 until a subset of arrays reach the program state.

FIG. 10 illustrates the structure of the persistent token bank (PTB) 1000 that can be used for managing stream ready tokens (SRTs) 1042. The PTB 1000 may comprise up/down counters (UDCs) that can be organized into two banks: a program odd bank 1010 and a program even bank 1020, which may be one for each physical stream associated with an odd/even program counter bit.

Each bank 1010, 1020 may contain UDCs for multiple streams, such as UDC Stream 1 1012, UDC Stream 2 1014, and UDC Stream N 1016 in the odd bank 1010, and UDC Stream 1 1022, UDC Stream 2 1024, and UDC Stream N 1026 in the even bank 1020. An SRT packet 1042, labeled as stream ready tokens (SRTs) 1042 with a stream identifier and program counter bit, that may be sent from the consumer CGR processor to the producer CGR processor. The stream identifier may identify a UDC tied to the physical stream and the program counter bit that may indicate an odd/even program counter from the consumer CGR processor. UDC values may be retained across program transitions from a first program state to a second program state. Upon receiving the SRT packet 1042, the corresponding UDC can be incremented to indicate the presence of a pending token for the identified stream, and decremented when the token is released to unblock the inter-processor stream.

The PTB 1000 may include a compare function 1030 that can compare the program counter bit from the SRT 1042 with a local program identifier 1044 of the producer CGR processor (e.g., the producer CGR processor program counter). The compare function 1030 may perform a bit-wise comparison to determine if the program counter bit of the SRT 1042 matches the least significant bit of the local program identifier 1044, indicating that the producer CGR processor and consumer CGR processor are in compatible program states. When a match may be determined, a token out 1050 may be generated to unblock the corresponding inter-processor stream. When the producer CGR processor may enter a first program state, all pending tokens in the bank corresponding to the first program state mod 2 may be released.

SRTs that may be marked as a second program state, which can be received asynchronously by a producer CGR processor in the first program state, may be held until the producer CGR processor advances to the second program state. The compiler may statically assign a physical stream identifier to each logical inter-processor stream and may program routes to the associated inter-processor transfer barrier.

While discussion herein refers to the SRTs being stored, in some examples, the SRT may not be stored in a storage location associated with the stream identifier and program counter bit may be up or down incremented, with the token output being generated based on the storage location association therewith. Alternatively, the stream identifier may be stored without the program counter bit. The subsequent comparison by the comparator may be whether the UDC bank matching the producer CGR processor program state mod 2 has a value of 1 (indicating a pending token), at which point the stream identifier is output as the token for the program state. Other variations would be apparent to one of ordinary skill in the art in view of this disclosure.

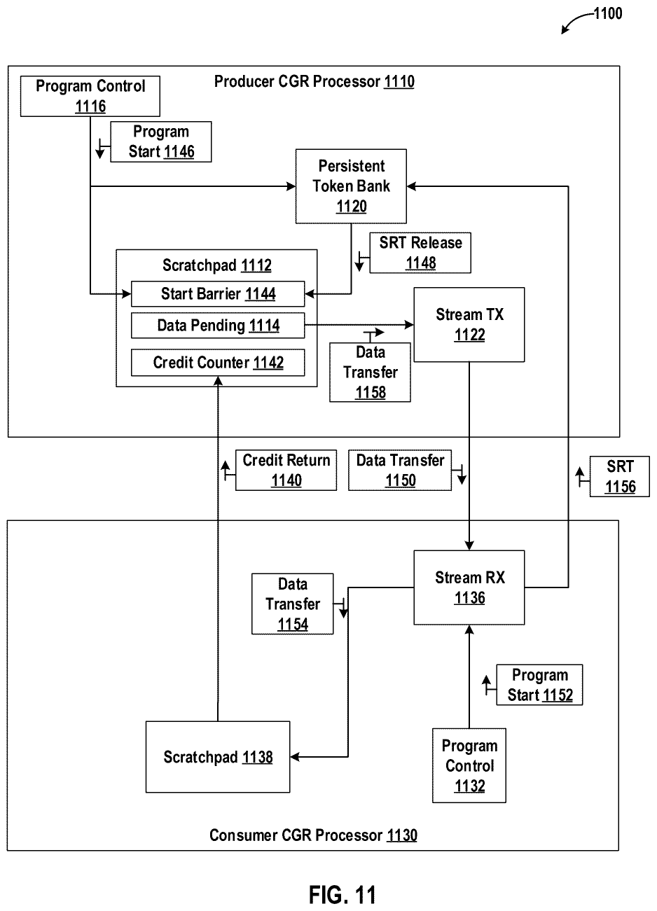

FIG. 11 illustrates a system 1100 in which a control handshake can occur between a producer CGR processor 1110 and a consumer CGR processor 1130 for pairwise synchronization. Data pending 1114 in a scratchpad 1112 on the producer CGR processor 1110 may be barred from transmission to the consumer CGR processor 1130 by a start barrier 1144, which can be stored in the scratchpad 1112 alongside a credit counter 1142.

When the producer CGR processor 1110 starts a first program state, a program start token 1146 may be sent from the program control 1116 to the scratchpad 1112, which can interact with the start barrier 1144 and data pending 1114. The producer CGR processor 1110 may then handle local processing but not begin inter-processor streams until unblocked by an SRT from the consumer CGR processor 1130.

When the consumer CGR processor 1130 starts the first program state, a program start token 1152 may be sent from the program control 1132 to the consumer Stream RX block 1136, which may form an SRT packet 1156 that can be relayed to the producer PTB 1120. The producer PTB 1120 may receive and handle the SRT 1156 as discussed above. When the producer CGR processor 1110 starts the first program state or when the SRT arrives (whichever is later), the PTB 1120 may release an SRT release 1148 to the producer Stream TX block 1122, which can unblock the inter-processor stream.

The pending data 1114 may then be transferred from the scratchpad 1112 to the Stream TX block 1122 via a data transfer 1158. The Stream TX block 1122 may then transfer the data 1114 to the consumer stream RX block 1136 via data transfer 1150. The consumer Stream RX block 1136 may then forward the received data via a data transfer 1154 to the consumer scratchpad 1138. Further SW credit control from consumer CGR processor 1130 to producer CGR processor 1110 may occur via a credit return 1140 from the consumer scratchpad 1138 to the producer scratchpad 1112, which can be managed by the credit counter 1142. The credit control operation may be separate from PTB 1120 because credit tokens from the consumer first program state may be guaranteed to arrive in the producer first program state.

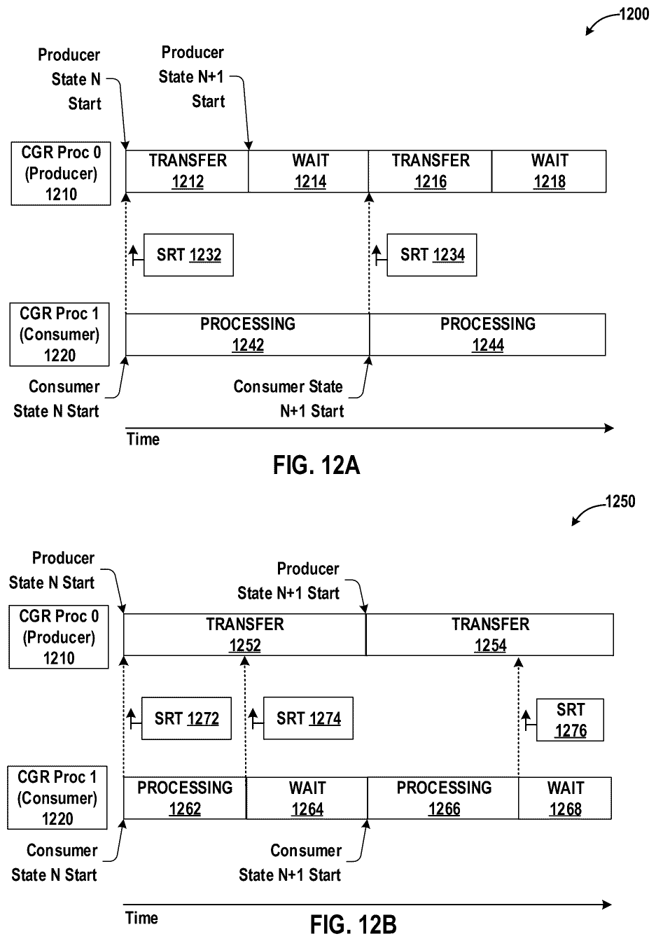

FIG. 12A illustrates synchronization latency where the producer leads the consumer for pairwise synchronization. FIG. 12A includes a producer CGR processor 1210 and a consumer CGR processor 1220 performing inter-processor streams based on pairwise synchronization.

As illustrated, the producer CGR processor 1210 may begin in a program state N indicated as Producer State N Start. However, as discussed below, initially, the producer CGR processor 1210 may wait for the consumer CGR processor 1220 to send an SRT before transferring data.

The consumer CGR processor 1220 enters program state N indicated as Consumer State N Start, begins processing in the processing state 1242 and sends SRT 1232 to the producer CGR processor 1210. The producer CGR processor 1210 receives the SRT 1232 from the consumer CGR processor 1220 and begins a transfer state 1212. The producer will continue the stream until complete, finalize the processing for program state N, then enter program state N+1 indicated as Producer State N+1 Start. As discussed above, the producer CGR processor 1210 may begin local processing but enters a waiting state 1214 while awaiting a SRT for program state N+1 before beginning the next inter-processor stream. Beginning local processing during the wait state may reduce the synchronization latency associated with waiting for the SRTs from the consumer CGR processor 1220 by overlapping the inter-processor synchronization with internal processing.

The consumer CGR processor 1220 receives the inter-processor stream for program state N and continues the processing state 1242 until completion of program state N. The consumer CGR processor 1220 may then enter program state N+1 indicated as Consumer State N+1 Start. As before, the consumer CGR processor 1220 may transmit an SRT 1234 to the producer CGR processor 1210, which may result in the handling of the transfer state 1216 and wait state 1218 for the producer CGR processor 1210 and the processing state 1244 for the consumer CGR processor 1220 in the manner discussed above.

FIG. 12B illustrates synchronization latency where the consumer leads the producer for pairwise synchronization. FIG. 12B includes a producer CGR processor 1210 and a consumer CGR processor 1220 performing inter-processor streams based on pairwise synchronization.

As illustrated, the producer CGR processor 1210 may begin in a program state N indicated as Producer State N Start. The producer CGR processor 1210 may wait for the consumer CGR processor 1220 to send an SRT before transferring data.

The consumer CGR processor 1220 may enter program state N indicated as Consumer State N Start, begin processing in the processing state 1262, and send SRT 1272 to the producer CGR processor 1210. The producer CGR processor 1210 may receive the SRT 1272 from the consumer CGR processor 1220 and begin a transfer state 1252 (which also includes further processing for program state N in this case). The consumer CGR processor 1220 may receive the inter-processor stream for program state N, complete processing in the processing state 1262, then enter program state N+1 indicated as Consumer State N+1 Start. The consumer CGR processor 1220 may send SRT 1274 to the producer CGR processor 1210 and enter a wait state 1264 because the consumer CGR processor 1220 leads the producer CGR processor 1210 in this example.

The producer CGR processor 1210 may continue the stream and processing for Program State N until complete, finalize the processing for program state N, then enter program state N+1 indicated as Producer State N+1 Start. The producer CGR processor 1210 may begin local processing but since the SRT 1274 for program state N+1 has already been received, the producer CGR processor 1210 may begin a transfer state 1254 without entering the wait state. The process may then continue with the consumer CGR processor 1220 exiting the wait state 1264 into the processing state 1266 before entering program state N+2 and the wait state 1268 while the producer CGR processor 1210 completes program state N+1.

Pairwise communication may utilize one-way communication from consumer CGR processor 1220 to producer CGR processor 1210 through the SRT token, and the SRT token latency may be reduced by allowing the producer CGR processor 1210 intra-processor streams to begin execution while inter-processor streams may wait for their respective SRT.

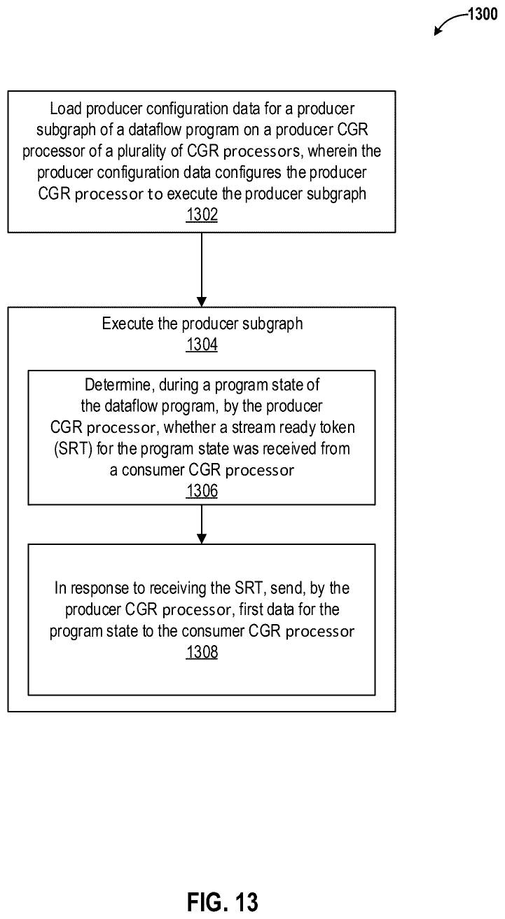

FIG. 13 is a flowchart of a process for synchronizing distributed dataflow programs using pairwise data-dependencies in a coarse-grained reconfigurable architecture (CGRA) comprising a plurality of coarse-grained reconfigurable processors (CGRPs).

At block 1302, a producer CGR processor of the plurality of CGR processors may load producer configuration data for a producer subgraph of a dataflow program, wherein the producer configuration data configures the producer CGR processor to execute the producer subgraph.

At block 1304 which may include block 1306 and 1308, the producer CGR processor may execute the producer subgraph. More particularly, at block 1306, the producer CGR processor may determine, during a program state of the dataflow program, by the producer CGR processor, whether a stream ready token (SRT) for the program state was received from a consumer CGR processor. At block 1308, the producer CGR processor may, in response to receiving the SRT, send first data for the program state to the consumer CGR processor.

### Considerations

The technology disclosed can be practiced as a system or method. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

Although the description has been described with respect to particular implementations thereof, these particular implementations are merely illustrative, and not restrictive. The description may reference specific structural implementations and methods and does not intend to limit the technology to the specifically disclosed implementations and methods. The technology may be practiced using other features, elements, methods, and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented on a printed circuit board (PCB) using off-the-shelf devices, in a System-on-Chip (SoC), application-specific integrated circuit (ASIC), programmable processor, GPU, or in a programmable logic device such as a field-programmable gate array (FPGA), obviating a need for at least part of the dedicated hardware. Implementations may be as a single chip, or as a multi-chip module (MCM) packaging multiple semiconductor dies in a single package. All such variations and modifications are to be considered within the ambit of the present invention the nature of which is to be determined from the foregoing description.

Any suitable programming language can be used to implement the routines of particular implementations including C, C++, Java, JavaScript, compiled languages, interpreted languages and scripts, assembly language, machine language, etc. Different programming techniques can be employed such as procedural or object-oriented. Methods embodied in routines can execute on a single processor device or on a multiple processor system. Although the steps, operations, or computations may be presented in a specific order, this order may be changed in different particular implementations. In some particular implementations, multiple steps shown as sequential in this specification can be performed at the same time.

Particular implementations may be implemented in a tangible, non-transitory computer-readable storage medium for use by or in connection with the instruction execution system, apparatus, board, or device. Particular implementations can be implemented in the form of control logic in software or hardware or a combination of both. The control logic, when executed by one or more processors, may be operable to perform that which is described in particular implementations. For example, a tangible non-transitory medium such as a hardware storage device can be used to store the control logic, which can include executable instructions.

It will also be appreciated that one or more of the elements depicted in the drawings/figures can also be implemented in a more separated or integrated manner, or even removed or rendered as inoperable in certain cases, as is useful in accordance with a particular application.

It should be noted that some of the operations of the disclosed method may be performed out of the order presented, with additional elements, and/or without some elements. Some of the operations of methods may further take place substantially concurrently and, therefore, may conclude in an order different from the order of operations shown above. Further, implementations are not limited to the details of the above examples and variations are possible.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system for synchronizing distributed dataflow programs using pairwise data-dependencies in a coarse-grained reconfigurable architecture (CGRA) including a plurality of coarse-grained reconfigurable processors (CGRPs), the system comprising:
a producer CGRP of the plurality of CGRPs configured to:
load producer configuration data for a producer subgraph of a dataflow program, wherein the producer configuration data configures the producer CGRP to execute the producer subgraph;
execute the producer subgraph to:
determine, during a program state of the dataflow program, whether a stream ready token (SRT) for the program state was received from a consumer CGRP; and
in response to receiving the SRT, send first data for the program state to the consumer CGRP.

2. The system of claim 1, wherein the producer CGRP is further configured to:
upon entering the program state, block an inter-processor stream for the first data to the consumer CGRP; and
in response to determining that the SRT was received, unblock the inter-processor stream before executing the producer subgraph to send the first data to the consumer CGRP.

3. The system of claim 2, wherein the producer CGRP is further configured to:
after entering the program state, perform intra-processor processing while the inter-processor stream is blocked.

4. The system of claim 2, wherein the producer CGRP comprises a persistent token bank (PTB) having up/down counters (UDCs) organized into an odd bank and an even bank, and wherein executing the producer subgraph to determine whether the SRT was received further comprises executing the producer subgraph to:
store, by the PTB, the SRT in the odd bank or the even bank based on a program identifier bit of the SRT associated with the program state; and
increment, by the PTB, a UDC associated with the SRT to indicate pendency of the SRT for the inter-processor stream.

5. The system of claim 1, wherein the producer CGRP is further configured to:
during execution of the dataflow program, send second data to a plurality of consumer CGRPs;
wait to transition to a next program state until a plurality of inter-processor streams respectively associated with the plurality of consumer CGRPs have completed sending the second data.

6. The system of claim 1, wherein the producer subgraph is disjoint from another subgraph of the dataflow program executed on a second producer CGRP, and wherein the producer CGRP is further configured to prevent transition to a next program state until a dummy synchronization token is received from the second producer CGRP.

7. The system of claim 6, wherein the producer CGRP and the consumer CGRP are configured to maintain, based on the SRT, a program skew of one program state with respect to the second producer CGRP.

8. The system of claim 1, wherein the consumer CGRP is further configured to:
load consumer configuration data for a consumer subgraph of the dataflow program, wherein the consumer configuration data configures the consumer CGRP to execute the consumer subgraph;
execute the consumer subgraph to:
upon entering the program state, block processing of the consumer subgraph;
send the SRT for the program state to the producer CGRP;
receive the first data from the producer CGRP via an inter-processor stream; and
in response to receiving the first data, unblock the processing of the consumer subgraph.

9. The system of claim 8, wherein the consumer CGRP is further configured to:
generate the SRT using a least significant bit of a program counter value for the program state for the consumer CGRP to indicate an odd program state or an even program state.

10. The system of claim 1, wherein the producer CGRP comprises a persistent token bank (PTB), and wherein the producer CGRP is further configured to:
store, in the PTB, an indication of a next SRT, received from the consumer CGRP, for a next program state until the execution of the dataflow program on the producer CGRP reaches the next program state.

11. A method for synchronizing distributed dataflow programs using pairwise data-dependencies in a coarse-grained reconfigurable architecture (CGRA) comprising a plurality of coarse-grained reconfigurable processors (CGRPs), the method comprising:
loading producer configuration data for a producer subgraph of a dataflow program on a producer CGR processor of the plurality of CGRPs, wherein the producer configuration data configures the producer CGRP to execute the producer subgraph;
executing the producer subgraph to:
determine, during a program state of the dataflow program, by the producer CGRP, whether a stream ready token (SRT) for the program state was received from a consumer CGRP; and
in response to receiving the SRT, send, by the producer CGRP, first data for the program state to the consumer CGRP.

12. The method of claim 11, wherein executing the producer subgraph further comprises:
upon entering the program state, blocking, by the producer CGRP, an inter-processor stream for the first data to the consumer CGRP; and
in response to determining that the SRT was received and before executing the producer subgraph to send the first data to the consumer CGRP, unblocking the inter-processor stream.

13. The method of claim 12, wherein executing the producer subgraph further comprises:
after entering the program state, performing, by the producer CGRP, intra-processor processing while the inter-processor stream is blocked.

14. The method of claim 11, wherein the producer CGRP comprises a persistent token bank (PTB) having up/down counters (UDCs) organized into an odd bank and an even bank, and wherein executing the producer subgraph to determine whether the SRT was received further comprises executing the producer subgraph to:
store, by the PTB, the SRT in the odd bank or the even bank based on a program identifier bit of the SRT associated with the program state; and
increment, by the PTB, a UDC associated with the SRT to indicate pendency of the SRT for the inter-processor stream.

15. The method of claim 11, wherein executing the producer subgraph further comprises:
during execution of the dataflow program, sending, by the producer CGRP, second data to a plurality of consumer CGRPs;
waiting, by the producer CGRP, to transition to a next program state until a plurality of inter-processor streams respectively associated with the plurality of consumer CGRPs have completed sending the second data.

16. A non-transitory computer-readable storage medium storing computer program instructions, wherein the computer program instructions, when executed on a processor, implement a method for synchronizing distributed dataflow programs using pairwise data-dependencies in a coarse-grained reconfigurable architecture (CGRA) comprising a plurality of coarse-grained reconfigurable processors (CGRPs), the method comprising:
executing a producer subgraph of a dataflow program on a producer CGRP of the CGRA to:
determine, during a program state of the dataflow program, whether a stream ready token (SRT) for the program state was received by the producer CGRP from a consumer CGRP; and
in response to receiving the SRT, send first data for the program state to the consumer CGR processor;
executing a consumer subgraph of the dataflow program on the consumer CGRP to:
upon entering the program state, block processing of the consumer subgraph on the consumer CGRP;
send the SRT for the program state to the producer CGRP;
receive the first data from the producer CGRP via the inter-processor stream; and
in response to receiving the first data, unblock the processing of the consumer subgraph.

17. The non-transitory computer-readable storage medium of claim 16, wherein executing the producer subgraph further comprises:
upon entering the program state, blocking, by the producer CGRP, the inter-processor stream to the consumer CGRP; and
in response to determining that the SRT was received and before executing the producer subgraph to send the first data to the consumer CGRP, unblocking the inter-processor stream.

18. The non-transitory computer-readable storage medium of claim 17, wherein executing the producer subgraph further comprises:
after entering the program state, performing, by the producer CGRP, intra-processor processing while the inter-processor stream is blocked.

19. The non-transitory computer-readable storage medium of claim 16, wherein the producer CGRP comprises a persistent token bank (PTB) having up/down counters (UDCs) organized into an odd bank and an even bank, and wherein executing the producer subgraph to determine whether the SRT was received further comprises executing the producer subgraph to:
store, by the PTB, the SRT in the odd bank or the even bank based on a program identifier bit of the SRT associated with the program state; and
increment, by the PTB, a UDC associated with the SRT to indicate pendency of the SRT for the inter-processor stream.

20. The non-transitory computer-readable storage medium of claim 16, wherein executing the producer subgraph further comprises:
during execution of the dataflow program, sending, by the producer CGRP, second data to a plurality of consumer CGRPs;
waiting, by the producer CGRP, to transition to a next program state until a plurality of inter-processor streams respectively associated with the plurality of consumer CGRPs have completed sending the second data.
